(19) United States
(12) Patent Application Publication
(10) Pub. No.: US 2014/0180567 A1
(43) Pub. Date: Jun. 26, 2014

(54) VEHICLE WITH DISTANCE MONITORING DEVICE

(71) Applicant: GM Global Technology Operations LLC, Detroit, MI (US)

(72) Inventor: Wolfgang FETSCH, Pfungstadt (DE)

(73) Assignee: GM GLOBAL TECHNOLOGY OPERATIONS LLC, Detroit, MI (US)

(21) Appl. No.: 14/136,568

(22) Filed: Dec. 20, 2013

(30) Foreign Application Priority Data
Dec. 20, 2012 (DE) 10 2012 024 930.6

(51) Int. Cl. G08G 1/16

(52) U.S. Cl. CPC G08G 1/167; G08G 1/168
USPC 701/301

(57) ABSTRACT

A vehicle has a distance monitoring device, which can be switched between a first operating mode for detecting the distance to an obstacle located in travelling direction and a second operating mode for measuring a distance transversely to the travelling direction to an obstacle and outputting a signal in real time that is representative of the measured distance.

### CROSS REFERENCE TO RELATED APPLICATION

This application claims priority to German Patent Application No. 10 2012 024 930.6 filed Dec. 20, 2012, which is incorporated herein by reference in its entirety.

### TECHNICAL FIELD

The technical field relates to a vehicle with a distance monitoring device for detecting the distance to an obstacle or between obstacles.

### BACKGROUND

Distance monitoring device for detecting the distance to an obstacle located in forward and reverse travelling direction in front of the vehicle are known by the designation parking aid and are widely used. By supplying a visual and/or acoustic signal that is representative of the measured distance, they make it possible for the driver when maneuvering into a parking space to drive up closer to an obstacle limiting the parking space at the front or back than with simple maneuvering by sight, without risking a collision because of this. These monitoring devices mostly comprise a plurality of ultrasound sender-receiver units, which are distributed along the front and rear bumper of a vehicle. In that the echo signals reflected on an obstacle and captured by the sender-receiver units are superimposed with different phase shifts to one another, obstacles, which are located so far sideward of the vehicle that there is no danger of a collision can be faded out of the signal detection and it can be determined by estimation and displayed if an obstacle is located centrally in front of the vehicle or more or less offset to the left or right against the vehicle middle.

When the vehicle travels with a normal cruising speed, such a parking aid is normally inactive, since the driver while travelling at travelling speed has to pay attention in the first place that the space monitored by the parking aid remains free of obstacles, and when in fact an obstacle enters the monitored space and is detected, the time remaining between detection and collision for methods that could still prevent a collision is not adequate.

Known are also parking assistance systems, which when driving past vehicles which are parked in a row are able with the help of such ultrasound sender-receiver units to detect when front or rear of a vehicle is being passed and from this estimate the length of a gap between two parking vehicles, and evaluate its suitability as a parking space.

In view of the foregoing, at least one object is to create a vehicle with a distance monitoring device, which offers a safety advantage even while travelling at a normal cruising speed. In addition, other objects, desirable features and characteristics will become apparent from the subsequent summary and detailed description, and the appended claims, taken in conjunction with the accompanying drawings and this background.

### SUMMARY

A vehicle is provided having a distance monitoring device the distance monitoring device can be switched in real time between a first operating mode for detecting a distance measured in travelling direction to an obstacle or between two obstacles and a second operating mode for measuring a distance transversely to the travelling direction to an obstacle and outputting a signal that is representative for the measured distance. Possible obstacles to be detected in the second operating mode include in particular a road boundary such as for example a curbstone, a guiderail or the like or vehicles on a neighboring lane. Since it is difficult for the driver of a motor vehicle to continuously and closely monitor the distance to obstacles on both sides of the vehicle, the invention offers a gain in safety while travelling on a narrow lane, in particular in the region of a construction site.

In order to be able to measure as parking aid the distance to an obstacle located in travelling direction in front or behind the vehicle, the distance monitoring device preferentially comprises at least one sender-receiver unit arranged on a bumper of the vehicle. If several units are distributed over the width of the bumper, at least one sender-receiver unit which is not directly arranged at an end of the bumper cannot emit directly into a space region laterally of the vehicle or receive an echo signal from this space region.

However, this is not particularly critical for the monitoring since an obstacle which is already located laterally of the vehicle hardly collides with it any longer. The possibility of a collision substantially consists only with an obstacle which, laterally offset against the travelling path of the vehicle, is still located in front of the vehicle and can therefore be beamed at by the sender-receiver units of the receiver units of the bumper which in travelling direction is located at the front.

The driver should have the possibility to arbitrarily switch manually between the two operating modes of the distance monitoring device. However in order to ensure that the distance monitoring device operates in the manner that is appropriate for the respective movement state of the vehicle, the distance monitoring device can be practically equipped to switch between the operating modes as a function of the travelling speed. A limit value for the operating mode switch-over can be selected in particular so that at speeds below approximately 10 km/h the first and at speeds above approximately 30 km/h the second operating mode is active.

The distance monitoring device should preferentially be able to differentiate between obstacles on different sides of the vehicle, in that it either responds only to obstacles on one side of the vehicle or emits two different signals, each of which is representative of the distance to an obstacle on one side of the vehicle. Preferentially, the distance monitoring device is equipped in order to monitor in the second operating mode the distance to an obstacle on the driver's side of the vehicle. Such a mode of operation is particularly appropriate for travelling on an overtaking lane on a highway construction site: by taking over the monitoring of the (generally slowly variable) distance to a road boundary on the driver's side, the distance monitoring device provides the driver with the possibility of monitoring the distance to vehicles on the co-driver's side, which, when vehicles are to be overtaken, can suddenly change from an overtaken vehicle to the next and therefore requires attentive, intelligent monitoring.

In order to make it easier for the driver to take into account the signal, this should only be able to assume a small number of discrete values. In the simplest case, these are two values. A first or quiescent value of the signal gives the driver the certainty that an adequate distance to the road boundary on the driver's side is maintained and that if he is able to maintain an adequate distance to a vehicle on a co-driver's side under these circumstances, overtaking is possible, whereas if an adequate distance to an adjacent vehicle is not attainable without the signal assuming the second or warning value, overtaking should be refrained from. A trivalent signal provides the driver with the possibility of maximizing the distance to vehicles on the co-driver's side to the extent that the signal assumes an intermediate value between quiescent value and warning value, in order to maintain both an adequate distance to the road boundary as well as minimizing a threat through sudden lateral movements of vehicles on the neighboring lane. A limit value of the distance, at which a switch between two discrete valued of the signal, preferentially the quiescent value and warning value takes place, should practically amount to below approximately 1 m, preferentially between approximately 0.75 and approximately 0.4 m.

The vehicle can comprise a signal generator activated by an output of the distance monitoring device with the signal of which the driver can estimate and take into account the detected distance. However, it is also conceivable with an output of the distance monitoring device to activate an automatic steering device of the vehicle in order to automatically trigger an evasive maneuver in the event of danger for example a steering movement, braking or both.

The signal generator can be visual or acoustic. An advantage of the optical signal generator is that it makes possible a representation of the detected distance that is high in resolution yet easily discernible by the driver. An advantage of the acoustic signal generator is that the driver can continuously monitor the distance to vehicles or other obstacles on a side of the vehicle himself and in the process is kept informed by the signal generator regarding the distance to obstacles on the side of the vehicle that is not monitored by him, himself.

### BRIEF DESCRIPTION OF THE DRAWINGS

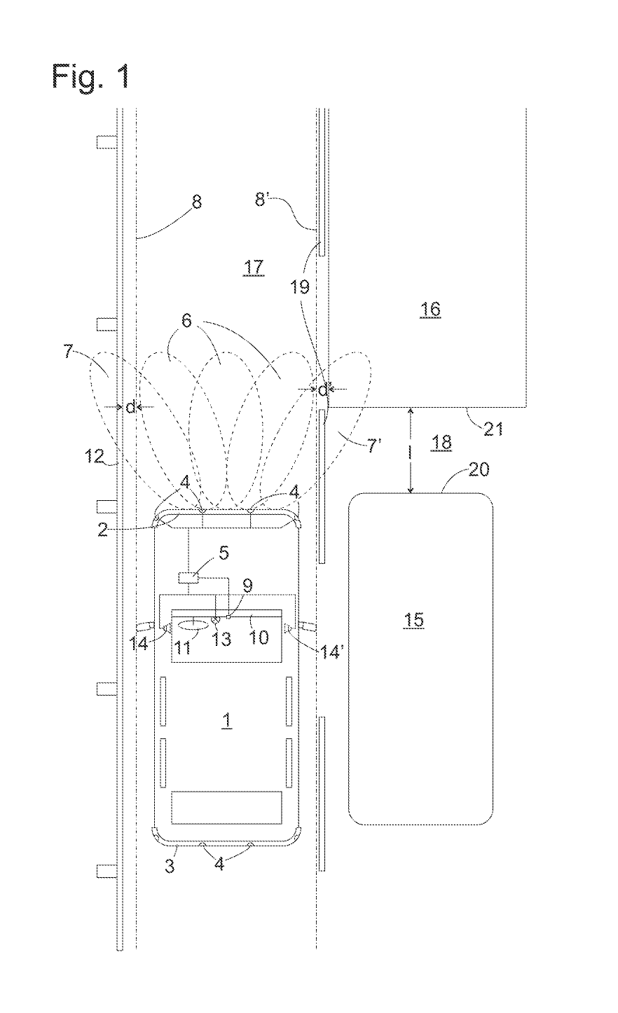

The present invention will hereinafter be described in conjunction with the following drawing FIG. 1, which is a schematic top view of a vehicle according to an embodiment in a typical traffic situation.

### DETAILED DESCRIPTION

The following detailed description is merely exemplary in nature and is not intended to limit application and uses. Furthermore, there is no intention to be bound by any theory presented in the preceding background or summary or the following detailed description

On a front and rear bumper 2 and 3 respectively, the vehicle 1 shown in FIG. 1 comprises a plurality of ultrasound sender/receiver units 4, in this case four each, which emit ultrasound waves coherently to one another and capture echoes of these waves reflected from the surroundings. The direction in which the ultrasound is emitted or the direction from which the returning echoes are best received is determined by the directional characteristic of the individual sender/receiver units 4 and by a phase shift between the sound waves emitted by the various units 4 or a phase shift, with which received echo signals of the units 4 are superimposed. A detection range 6, 7 or 7′ each, in which when using this set existing obstacles are detected, thus corresponds to a given set of phase shifts. In that an electronic control unit 5 switches between the different sets of phase shifts can investigate the different detection ranges 6 for the presence of obstacles and if applicable estimate the distance of a detected obstacle from the vehicle.

The control unit 5 supports two operating modes, a parking support mode and a mode for supporting the driver on a narrow lane. In the parking support mode, the control unit 5, when maneuvering into a parking space, utilizes the sender/receiver units 4 of the bumper located in the respective current travelling direction at the front, i.e., when travelling forward that of the front bumper 2 and when travelling in reverse, that of the rear bumper 3. In the parking support mode, the sender/receiver units 4 operate with phase shifts, which in each case correspond to detection ranges 6 as shown in the figure, which transversely to the travelling direction do not substantially extend over the most lateral points of the vehicle 1, in this case the outside mirrors. In this way, preferably exactly only the traffic space extending between two dash-dotted boundary lines 8, 8′ in FIG. 1 is monitored, which the vehicle 1 will probably occupy when driving on. Obstacles on the other side of the boundary lines 8, which the vehicle will pass without contact when travelling on, are not detected.

Instead of the parking aid mode or additionally to the latter, a parking space search mode can be supported. In this way, a detection range located laterally, typically the detection range 7′ located the farthest on the co-driver's side is utilized in order to detect when front 20 or rear of vehicles are parked next to the vehicle 1 are passed. By means of the time span between the time of detection and the speed of the vehicle 1, the length I of a gap between the parked vehicle and their suitability as parking space can be evaluated.

To determine the operating mode, the control unit 5 is connected to a selector switch 9 in the instrument panel 10 of the vehicle 1 that can be actuated by the driver. The selector switch 9 can be a simple on-off switch, which in a first position activates the parking aid operating mode and/or the parking space search mode and in a second position activates a narrow lane travel operating mode of the control unit 5. A third switch position can be provided in which the control unit 5 is inactive.

Alternatively or additionally, a position of the selector switch 9 can be provided, in which the control unit 5 selects the operating mode as a function of the speed of the vehicle 1: at a speed of the vehicle 1 of for example less than approximately 10 km/h, the parking aid operating mode and/or the parking space search mode should then be active, at a speed above approximately 30 km/h, the narrow lane travel operating mode. Activation of the narrow lane travel operating mode could also be effected by remote control, for example from a radio beacon erected at a road constriction or through communication with a vehicle travelling ahead.

In the narrow lane travel operating mode, the phase shifts between the sender/receiver units 4 are determined so that a detection range 7 is obtained, which for a major part extends on the other side of one of the boundary lines 8, 8′. In the case considered here, this detection range 7 is located on the same side of the vehicle 1 as a steering wheel 11, i.e. in a vehicle designed for right-hand traffic, on the left side. Naturally, it would also be conceivable in principle to monitor a detection range on the other side of the boundary line 8′ facing away from the steering wheel 11, in this case on the right side of the vehicle.

By means of the echo received from the detection range 7, the control unit 5 calculates the distance d measured transversely to the travelling direction of the vehicle 1, i.e. perpendicularly to the left boundary line 8 to an obstacle 12 located laterally of the vehicle, in this case a guiderail. An indicating instrument 13 is provided on the instrument panel 10 in order to indicate the result of the calculation. The indicating instrument 13 can be designed in order to indicate the numerical value of the distance d calculated by the control unit 5 in an analogue or digital manner; it is also conceivable that the indicating instrument 13 brings the distance measured to the attention of the driver by switching between different discrete operating states. Thus, a color for example in which the indicating instrument 13 is illuminated, can be switched depending on the value of the distance between different colors, e.g. green for an adequate distance including safety margin, e.g., approximately d>0.5 m, orange for an adequate distance without safety margin, e.g., approximately 0.5 m<approximately d<0.35 m, and red for an inadequate distance, e.g. approximately d<0.35 m, or the display instrument switches between continuous or flashing illumination depending on the value of the distance d. The values of the distance at which a switch between the different operating states of the indicating instrument 13 takes place could also be predetermined as a function of the speed of the vehicle 1.

An acoustic signal generator 14 in this case is likewise connected to the control unit 5 in order to be able to inform the driver that the obstacle 12 is being approached, when said driver does not look at the instrument panel 10. The signal generator 14 can be largely arbitrarily placed in the passenger cell of the vehicle 1. In that, as shown in the figure, it is attached to the same side of the vehicle 1 on which the distance d to the obstacle 12 is also measured, the direction from which the danger threatens can also be made clear to the driver at the same time through the direction from which the sound emanates if the signal generator 14 generates a sound in the event of danger.

The signal generator 14 is practically still, for as long as the adequate distance plus the safety margin to the obstacle 12 is maintained. A first signal tone is generated when the vehicle 1 enters the safety margin and a second one when the safety margin is used up and the distance d is no longer adequate. This makes it possible for the driver when, on a narrow lane, in particular on a highway construction site, he overtakes vehicles 15, 16 on a lane 18 adjoining the lane 17 travelled by the driver himself on the right, to continuously keep an eye on these vehicles 15, 16 and maintain a safe distance to them. Thus, he can for example in the configuration shown in FIG. 1 overtake a passenger car 15 on the neighboring lane 18 without danger. A commercial vehicle 16 travelling ahead however is closer to the center line 19 between the two lanes 17, 18 than the passenger car 15. If the driver of the vehicle 1, in order to also overtake the commercial vehicle 16 and in the process maintain an adequate distance to the latter, steers the vehicle 1 on its lane 17 to the left and the signal generator 14 remains still in the process, it can also overtake the commercial vehicle 16. However, if the signal generator 14 supplies a warning signal, the driver knows that the lane width is not sufficient for safe overtaking and that he should wait for the end of the construction site before overtaking.

According to a further embodiment, the control unit 5 can be designed in order to also monitor a detection range 7′, which in part extends on the other side of the boundary line 8′ on the co-driver's side. In the configuration shown in FIG. 1, the commercial vehicle 16 extends into this detection range 7′, so that it is detected and its distance d′ from the boundary line 8′ is measured. If this distance d′ is smaller than a minimum safety distance (which in the case of a vehicle such as the commercial vehicle 16 should be larger than the distance to a stationary obstacle such as for example the guiderail), a warning signal is output via a signal generator 14′ on the co-driver's side, and the driver knows that safe overtaking is only possible when both signal generators 14, 14′ are still.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A vehicle, comprising:
with a distance monitoring device that is configured to supports a first operating mode for detecting a distance measured in a travelling direction to an obstacle,
wherein the distance monitoring device is further configured to support a second operating mode for measuring a distance transversely to the travelling direction to an obstacle and outputting a signal in real time that is representative of the measured distance.

2. The vehicle according to claim 1, wherein the distance monitoring device comprises sender-receiver unit on a bumper of the vehicle.

3. The vehicle according to claim 1, wherein the first operating mode of the distance monitoring device is manually settable.

4. The vehicle according to claim 1, wherein the distance monitoring device is configured to switch between the first operating mode and the second operating mode as a function of a travelling speed.

5. The vehicle according to claim 1, wherein the distance monitoring device is configured to monitor the distance to an obstacle on a driver side of the vehicle in the second operating mode.

6. The vehicle according to claim 5, wherein the signal assumes discrete values, preferentially two or three discrete values.

7. The vehicle according to claim 6, wherein a limit value of the distance, above which the signal assumes a first value, and below which it assumes a second value of approximately 1 m.

8. The vehicle according to claim 1, further comprising a signal generator activated by an output of the distance monitoring device that generates a perceptible signal.

9. The vehicle according to claim 8, wherein the signal generator is an acoustic signal generator.

10. The vehicle according to claim 9, wherein the signal generator is arranged on a monitored side of the vehicle.

11. The vehicle according to claim 6, wherein a limit value of the distance, above which the signal assumes a first value, and below which it assumes a second value below between approximately 0.75 and approximately 0.4 m.

12. The vehicle according to claim 6, wherein the signal assumes at least two or three discrete values.

13. The vehicle according to claim 6, wherein the signal assumes at least three discrete values.
